(19) United States
(12) Patent Application Publication
(10) Pub. No.: US 2006/0083442 A1
(43) Pub. Date: Apr. 20, 2006

(54) Image archiving system and method

(75) Inventors: Evgueni Nikos Loukipoudis, Waasmunster (BE); Raymond Joe Brunsting, Waterloo (CA); Jeffery Frederick Avery, Waterloo (CA)

Correspondence Address: BERESKIN AND PARR, 40 KING STREET WEST, BOX 401, TORONTO, ON, M5H 3Y2, CA

(73) Assignee: Agfa Inc., Toronto (CA)

(21) Appl. No.: 10/964,782

(22) Filed: Oct. 15, 2004

(51) Int. Cl. G06K 9/54

(52) U.S. Cl. 382/305

(57) ABSTRACT

An image archiving system includes imaging modalities, an acquisition workstation and a number of PACS networks. Each PACS network includes storage access points that access and provide medical image meta-data from a clinical database and image data files from temporary and permanent storage areas and to a plurality of clients. The temporary and permanent storage areas each have a location repository and a storage device for storing medical images and the details associated with the image data. When triggering events occur, image data files stored in a permanent storage area are considered for deletion and image data file copies stored in a temporary storage area are considered for replacement. Various selection criteria and indicia are used to determine whether or not to delete or replace image data files.

### FIELD OF THE INVENTION

This invention relates generally to the field of image archiving and particularly to an improved image archiving system and method.

### BACKGROUND OF THE INVENTION

Medical imaging has been an expanding field for several decades. With increasing diagnostic tools, increasing population, more wide-spread access to medical treatment, and the desirability of sharing information between doctors and professionals, medical imaging is likely to continue growing. To address this continued growth, and the subsequent inconveniences of paper and other fixed forms of medical image storage, the medical community has increasingly turned to digital forms of image storage.

Picture Archiving and Communications Systems (PACS) are a popular example of a digital image system. These systems connect elements such as imaging modalities, storage databases or areas, clients that use the medical image data, and data processing devices to create a network of imaging technology. Such systems then provide easier remote diagnosis and data access, sharing of information between health-care professionals, and ultimately a better health-care system.

Digital storage media continues to be developed with recent storage technologies such as hard disks, digital video discs (DVD) and compact discs (CD) having ever increasing storage potential. However, the image data that is being generated by modalities and other health related equipment is increasing faster than conventional storage technologies can accommodate. This is in part due to the increased number of images being captured as well as the prevalence of higher resolution images that are being generated by newer modalities and other heath related equipment. Accordingly, it not always practical for all digital medical images to be permanently stored in their original, uncompressed format. However, at the same time, there is also a growing desire by users of medical imaging equipment to maintain “on-line” versions of all historical data associated with a patient. These competing realities make it prohibitively expensive to keep all of the original image data available to the user.

### SUMMARY OF THE INVENTION

The invention provides in one aspect, an image archiving system for archiving an original image data file associated with an image, said image archiving system comprising:

(a) a permanent storage area for storing the original image data file associated with the image;

(b) a temporary storage area for storing first and second copies of the original image data file associated with the image;

(c) a processor coupled to said permanent and first temporary storage areas, said processor being adapted to:
(i) determine whether a triggering event has occurred;
(ii) if (i) is true, determine whether to replace one of the first and second copies of the original image data file within the temporary storage area;
(iii) if (ii) is true, determine whether the size of one of the said first and second copies of the original image data file is less than the size of the other of first and second copies of the original image data file and whether the said other of first and second copies of the original image data file could be derived from said one of the first and second copies of the original image data file;
(iv) if (iii) is true then replace the said other of first and second copies of the original image data file with said one of the said first and second copies of the original image data file.

The invention provides in another aspect, a method for archiving an original image data file associated with an image, said method comprising:

(a) storing the original image data file associated with the image in a primary storage area;

(b) storing first and second copies of the original image data file in a temporary storage area;

(c) determining whether a triggering event has occurred;

(d) if (c) is true, determining whether to replace one of the first and second copies of the original image data file within the temporary storage area;

(e) If (d) is true, determining whether the size of one of the said first and second copies of the original image data file is less than the size of the other of first and second copies of the original image data file and whether the said other of first and second copies of the original image data file could be derived from said one of the first and second copies of the original image data file; and

(f) if (e) is true then replacing the said other of first and second copies of the original image data file with said one of the said first and second copies of the original image data file.

The invention provides in another aspect, an image archiving system for archiving an original image data file associated with an image, said image archiving system comprising:

(a) a permanent storage area for storing the original image data file associated with the image;

(b) a processor coupled to said permanent area, said processor being adapted to:
(i) determine whether a triggering event has occurred;
(ii) if (i) is true, determine whether to delete the original image data file from the permanent storage area, and if so, deleting the original image data file from the permanent storage area.

The invention provides in another aspect, a method for archiving an original image data file associated with an image, said method comprising:

(a) storing the original image data file associated with the image in a primary storage area;

(b) determining whether a triggering event has occurred;

(c) if (b) is true, determining whether to delete the original image data file from the permanent storage area, and if so, deleting the original image data file from the permanent storage area.

Further aspects and advantages of the invention will appear from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show some examples of the present invention, and in which:

FIG. 1 is a block diagram of the basic components of the image archiving system of the present invention;

FIG. 2 is a flowchart illustrating the basic operational steps of the image archiving system of FIG. 1;

FIG. 3 is a block diagram illustrating in more detail the local and remote aspects of the image archiving system of FIG. 1;

FIG. 4 is a flowchart illustrating in more detail the operational steps of the image archiving system of FIG. 1;

FIG. 5 is a flowchart illustrating in more detail the operational steps of the image archiving system of FIG. 1; and

FIG. 6 is a flowchart illustrating in more detail the operational steps of the image archiving system of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

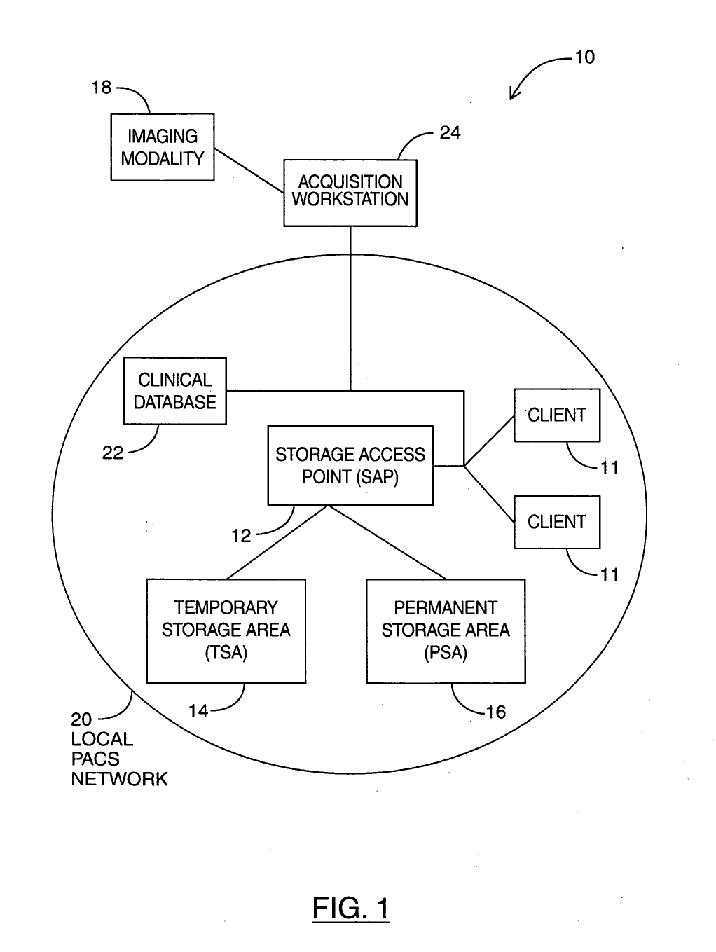

Reference is first made to FIG. 1, which illustrates the components of an image archiving system 10 made in accordance with a preferred embodiment of the present invention. The image archiving system 10 includes an imaging modality 18, an acquisition workstation 24 and a local Picture Archiving and Communications Systems (PACS) network 20. Imaging modality 18 generates conventional medical image data (e.g. x-ray images, CT scan images, MRI images, etc.). This medical image data is then acquired by the acquisition workstation 24 and stored as image data files in the local PACS network 20. The local PACS network 20 further comprises a plurality of clients 11, a storage access point (SAP) 12, a clinical database 22, a temporary storage area (TSA) 14, and a permanent storage area (PSA) 16. Image archiving system 10 provides intelligent deletion and replacement of image data files within temporary and permanent storage areas 14 and 16, to maintain a digital medical imaging system that is capable of handling large volumes and sizes of image data files.

The imaging modality 18 provides image data to the acquisition workstation 24 in analog or any digital format used to represent medical image data (e.g. bitmaps, JPEGs, GIFs, etc.). The acquisition workstation 24 then converts the image data into a digital format (i.e. an image data file) suitable for storage in the permanent storage area 16 or the temporary storage area 14 as appropriate.

The acquisition workstation 24 may be a personal computer (e.g. a PC) or server that is physically separate from the imaging modality 18, or the acquisition workstation 24 may be separably or inseparably connected to the imaging modality 18. The acquisition workstation 24 may also be a client 11 functioning as an acquisition workstation 24.

When medical image data associated with medical images is provided to the local PACS network 20 from the acquisition workstation 24, the storage access point 12 provides a copy of the image data files to the permanent storage area 16 for storage. Medical image meta-data such as patient identifiers, patient names, study descriptions and image descriptions are obtained from the image data provided by the imaging modality 18 and stored at the clinical database 22. The clients 11 of the local PACS network 20 are then able to access image data files from the temporary and permanent storage areas 14 and 16 and image meta-data discussed above from the clinical database 22. Accordingly, it should be understood that the term “image data” as used in the present disclosure will encompass “image data files” which is stored in and accessed from temporary and permanent storage areas 14 and image meta-data that is stored in the clinical database 22.

Client 11 is any computing device that accesses medical image data, including but not limited to, PCs, server computers, handheld electronic devices such as personal digital assistants and cell phones. Clients 11 in the local PACS network 20 directly access the medical image meta-data located in the clinical database 22. Clients 11 can also access image data files that are referenced within clinical database 22 but located in either the permanent storage area 16 or the temporary storage area 14 via the storage access point 12. Clients 11 accessing image data files outside of their local PACS network 20 access images from another local PACS network's 20 temporary storage area 14 or permanent storage area 16 through an associated storage access point 12. The associated storage access point 12 copies desired image data files into the temporary storage area 14 of the local PACS network 20. Clients 11 then access the image data files from their local temporary storage area 14.

The storage access point 12 receives a request for image data from a client 11, determines the location of the requested image data in either the temporary storage area 14 or the permanent storage area 16 and provides the client 11 access to the image data files. The storage access point 12 is preferably implemented in software running on a PC or on a server computer. The storage access point 12 is able to communicate with many of the components of the image archiving system 10 and acts as a communications hub for the system.

The temporary storage area 14 and permanent storage area 16 are structurally similar and are used for storage and retrieval of medical image data files among other things. Although the temporary storage area 14 and permanent storage area 16 store medical image data, they may also be used to store other information not related to the image archiving system 10 (e.g. patient lists, reports, etc.).

The permanent storage area 16 is used to store original image data associated with an image from multiple imaging modalities 18. This image data normally represents the most detailed version of an image provided by imaging modality 18 and is stored in an unaltered form. This image data thus typically requires a lot of storage space and will be subject to archiving within the image archiving system 10 being described. Original image data files stored within permanent storage area 16 are typically backed up for damage recovery retrieval purposes (e.g. tape backups stored off-site). It should be understood that permanent storage area 16 does not store any “derived versions” or “copies” of original image data files. Rather, permanent storage area 16 either contains the original version of an image data file or nothing at all (i.e. when the image data file is deemed suitable for deletion).

The temporary storage area 14 stores compressed, filtered and modified image data files derived from the original version of the image data as will be described. Image data files stored in the temporary storage area 14 are normally not associated with image data files stored in a permanent storage area 16 located outside of the local PACS network 20, although it should be understood that the temporary storage area 14 may also store original image files that are copied from a “remote” permanent storage area 16. Image data stored on the temporary storage area 14 may occasionally be deleted as original images are not normally located there, making archiving of the temporary storage area 14 less important.

However, it is preferable in one example of the invention to ensure that at least one derived version of any image data that is desired to be accessible within image retrieval system 10 is maintained within a temporary storage area 14. As an illustration, a new medical exam is stored in a local permanent storage area 16 for a period of time (e.g. months) and then eventually the copy of the medical exam will be removed to make room for new image files. However, a derived (i.e. compressed) version of the image file will remain in the temporary storage area 14 associated with the local PACS network 20 indefinitely.

In case of a disaster (i.e. loss of a temporary storage area 14) the original images may need to recovered from backup media, and perhaps recompressed for storage in a temporary storage area 14 again. This recovery may happen on an as-needed basis if/when the image data are requested in the future, or an entire lost temporary storage area 14 can be rebuilt using information contained in the location repository about what was stored in the failed temporary storage area 14.

Although the components of the local PACS network 20 are depicted as separate elements, it should be understood by those skilled in the art that a client 11, an storage access point 12, a temporary storage area 14, a permanent storage area 16 and a clinical database 22 may all be separably or inseparably connected (e.g. in a PC or a server computer).

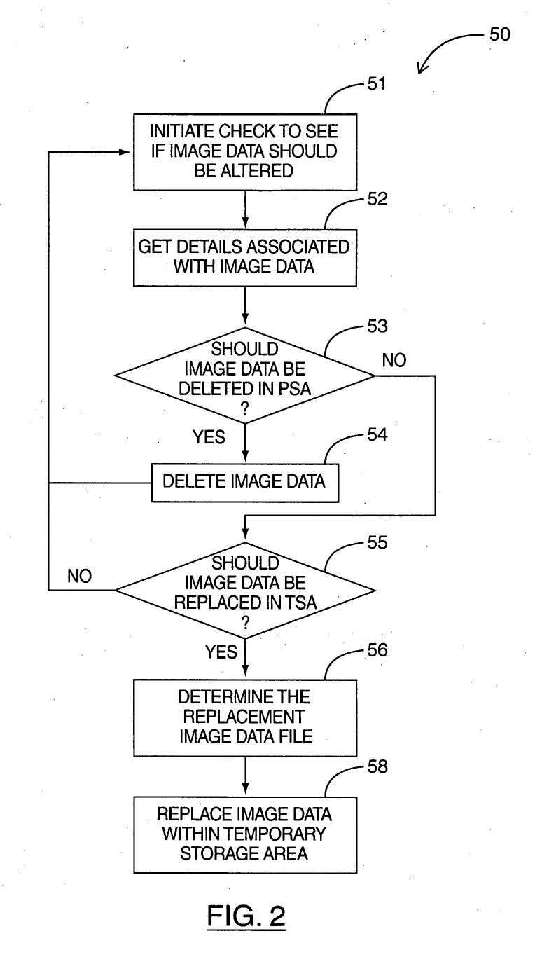

FIG. 2 is a flowchart illustrating the basic operational steps 50 of the image archiving system 10. Operation begins at step (51) where the image archiving system 10 initiates a check to see if the image data file associated with an image stored in the temporary storage area 14 and/or the permanent storage area 16 should be altered (i.e. reduced or deleted). Specifically, it should be understood that image archiving system 10 periodically checks to see whether the size of an image data file can be reduced within temporary storage area 14 and/or whether an image data file can be deleted from permanent storage area 16.

Initiation of a check may be caused, for example, when size limits for an image data file (as established for the local PACS network 20) are exceeded, or when time limits (as established by the local PACS network 20) are exceeded. Once initiated, the check at step (51) can operate in different ways. The check can operate on one image at a time, one permanent storage area 16 at a time, on a full study (a set of images produced by one or more examinations), or on the entire system.

Once a check has been initiated at step (51), various details concerning the image at issue are obtained at step (52). Specifically, storage access point 12 obtains information from multiple sources including, but not limited to, permanent storage areas 16, temporary storage areas 14, clinical database 22, the image itself, storage access point 12, acquisition workstation 24, and the imaging modality 18. Image size, storage time, location, imaging modality type and other such details are gathered.

At step (53), the storage access point 12 determines whether the image data at issue should be deleted from the permanent storage area 16. This determination can be configurable by a user or operator of the image archiving system 10 and/or it can be made based on a number of key factors. Factors which suggest that the image data should be deleted include: aged image data; image data created by aged imaging modality; high image quality degradation; unnecessary routine images; images that assisted with diagnosis but have no further diagnostic value (i.e. low clinical relevancy). Factors which suggest that the image data should be retained include: unique image data; image data associated with unique imaging modality or unique diagnosis; high quality image data; the image containing genetic information useful for future analysis involving hereditary diseases (i.e. high clinical relevancy).

If at step (53), it is determined that the image data associated with an image is to be deleted, then at step (54) image data file is deleted from permanent storage area 16. At any point in time, an original copy of an image data file will be stored in the permanent storage area 16 and a compressed version will be stored in a temporary storage area 14 (and possibly multiple versions stored in multiple temporary storage areas 14). The original image data file in the permanent storage area 16 will only be deleted if it has been determined that such image data should be delete at step (53) and if a copy has been found in one or more temporary storage areas 14 as will be discussed. It should be noted that meta-data will exist indefinitely in the clinical database 22 until an administrator explicitly deletes the meta-data.

At step (55), it is determined using similar factors to those noted above in respect of the deletion determination for image data files in the permanent storage area 16 as to whether an image data file associated with an image should be replaced within a temporary storage area 14. Factors which suggest that the image data should be replaced include: aged image data; image data created by aged imaging modality; high image quality degradation; unnecessary routine images; images that assisted with diagnosis but have no further diagnostic value (i.e. low clinical relevancy). Factors which suggest that the image data should not be replaced include: unique image data; image data associated with unique imaging modality or unique diagnosis; high quality image data; the image containing genetic information useful for future analysis involving hereditary diseases (i.e. high clinical relevancy). If the image is to be replaced, the process carries on to step (56).

At step (56), the system determines which image data file will be retained within various temporary storage areas 14. This involves locating each copy of all image data files that exist in temporary storage areas 14 of the local PACS network 20 as well as the entire image archiving system 10 and determining the smallest image data file (i.e. the most “lossy version” where the most detail has been lost) that contains enough information to allow all required versions of the image to be “derived” or obtained through filtering, compressing etc. The specific required versions, as well as the degree to which an image may lose detail, is preferably determined by the local PACS network 20 or the image archiving system 10. It is contemplated that the particular acceptable level of “lossiness” (i.e. amount of lost detail) would be established on a site-by-site basis. That is, a determination needs to be made as to the acceptable level of compression/lossiness and such acceptable levels used within image archiving system 10.

Finally, at step (58) it is ensured that the image data file that is selected in step (56) is stored at least one temporary storage area(s) 14. It should be understood that if the image data file is already stored in one or more temporary storage areas 14 then the image data file will simply be left there.

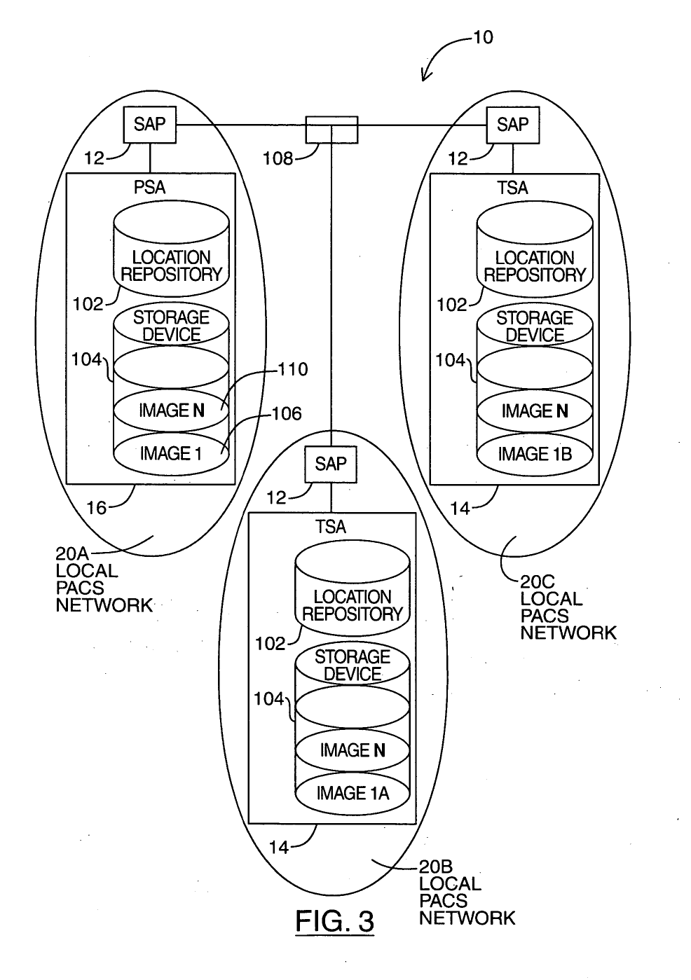

Referring now to FIG. 3, a larger-scale example of the image archiving system 10 is illustrated. FIG. 3 is a block diagram illustrating in more detail the local and remote aspects of the image archiving system 10 of FIG. 1. The exemplary image archiving system 10 depicted includes multiple local PACS networks 20A, 20B, 20C, and PACS network connections 108. The multiple local PACS networks 20A, 20B, 20C, are connected to each other by the PACS network connections and are able to communicate with each other.

Each local PACS network 20 includes a storage access point 12, a temporary storage area 14 and a permanent storage area 16. For illustrative purposes in FIG. 3, only the permanent storage area 16 and storage access point 12 of local PACS network 20A are shown, while only the temporary storage area 14 and the storage access point 12 of local PACS networks 20B and 20C are shown. With each local PACS network 20A, 20B and 20C, the storage access point 12 communicates with the temporary storage area 14 and the permanent storage area 16 to provide read and write access to medical image data files. The permanent storage area 16 and temporary storage area 14 further comprises a location repository 102 and a storage device 104. The location repository 102 stores information about the image 1 106 to image N 110 image data files that are stored in storage device 104.

The information stored in location repository 102 could include, but is not limited to, a unique image identifier, any filtering or compression processes used to arrive at the stored version from the original copy, the size of the image, the number of times the image data file has been accessed, the first time the image data file was accessed, the last time the image data file was accessed, when the image data file was stored, what imaging modality created the image, and the medical uses for the image. Storage access point 12 searches location repository 102 using a unique image identifier and preferably selectively accesses information stored in the location repository 102 associated with the target image. Storage access point 12 is also able to read and write information in the location repository 102. The location repository 102 is preferably implemented as a database schema describing the logical volume and the data stored on each in sufficient detail for the storage access point 12 to access the logical volumes (i.e. storage devices).

Each storage device 104 is a conventional storage device that supports efficient storing, searching and retrieving of location information associated with medical image data files obtained from imaging modalities 18. Storage device 104 may further store report data. The storage access point 12 communicates with the storage device 104 through the temporary storage area 14 or permanent storage area 16. The storage access point 12 also writes image data files to the storage device 104, and reads image data files from the storage device 104. A unique identifier is preferably used for reading the image data file or writing the image data file to a specified location. The unique identifier is preferably a handle to a specified location in the storage device 104. The storage device 104 can be implemented using any conventional storage devices, such as, Redundant Array of Independent Disks (RAID), a Tape Library, a CD/DVD jukebox, a Network Attached Storage (NAS) or a Storage Area Network (SAN). Selecting how to implement the storage device 104 will depend on factors such as cost, customer preference, and performance requirements. The storage device 104, regardless of how it is implemented, will have readers and writers that allow access to the data stored therein.

The network connection 108 allows local PACS networks 20A, 20B, 20C to communicate with each other. FIG. 3 shows one example where three local PACS networks 20A to 20C are all connected with network connections 108. These connections may be connections directly between two local PACS networks 20 or may be connections between a local PACS network 20 and a hub (not shown) that directs communication between local PACS networks 20. The network connections 108 may be implemented similar to intranet network connections, and this may include Ethernet technologies, wireless technologies, RS-232 serial communications, infrared or Bluetooth communications, or any other network protocols or methods.

Image 1 106 and image N 110 are image data files associated with images from an imaging modality 18. These images are generated by a variety of imaging modality 18, and are of a variety of areas of the human body, and are stored in various digital formats, (e.g. GIF, JPEG, bitmaps, etc.).

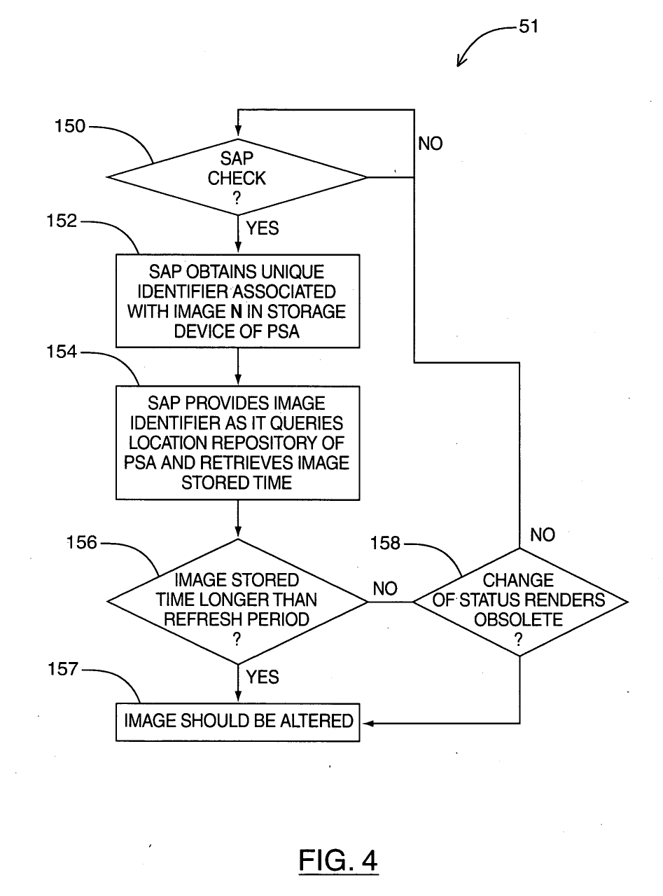

FIG. 4 is a flowchart illustrating in more detail the operational steps of the image archiving system 10 of FIG. 2 and in particular a more detailed description of one example implementation of the process step (51) of FIG. 2. As previously noted, the operation of the archiving system 10 begins at step (51) of FIG. 2 where the image archiving system 10 initiates a check to see if the image data associated with a particular image should be replaced.

At step (150), storage access point 12 initiates a status check. Storage access point 12 preferably utilizes a timer (not shown) to ensure that periodic checks are made as to whether image data files should be deleted from permanent storage area 16 and/or consolidated within temporary storage area 14. The operation particulars of the timer is set by a local PACS network 20, or the entire collection of PACS networks. The timer is preferably operated from a central location in the collection of PACS networks and used by the individual local PACS networks 20, although it is also possible for a timer to be associated with individual local PACS networks 20.

The use of a timer allows image archiving system 10 to handle deletion/replacement criterion that is related to age of an image data file. For example, for a certain class of image data files (e.g. fracture-related x-ray images) a lifetime of five years may be set by the local PACS network 20 after which the image data file should be deleted. When the timer indicates that five years has elapsed since the creation or an image data file in this class, then this image data file will be scrutinized for deletion/replacement as discussed above.

Alternatively, a check may be initiated by a change of status for the image or the patient (e.g. someone has viewed the image, a doctor has dictated into a study containing the image, a report has been approved, or a patient has passed away or been discharged, etc.) More generally, any change to criterion that is useful in terms of determining availability for deletion or replacement may be used as a triggering event at step (150).

If the check at step (150) determines that a triggering event has occurred, then at step (152) the storage access point 12 retrieves a unique identifier associated with the target image (e.g. image N) stored in the storage device 104 of the permanent storage area 16. For illustration purposes, it should be assumed that image N is either the sole image that image archiving system 10 is operating on, or one particular image within a number of images that is being operated on. In one example implementation, the unique identifier of image N is preferably stored in the image data file and includes information about the imaging modality 18 that captured the image, the size of the image, and an associated timestamp. In a second example, the unique identifier could simply be a handle to the location in the storage device 104 where the image data file is located.

When the unique identifier is received at step (152), the storage access point 12 provides this unique identifier to the location repository 102 at step (154). The storage access point 12 requests from the location repository 102, the stored time (i.e. duration of storage) of the target image data file that is identified by the unique identifier. Based on the retrieved stored time for the target image data file, the storage access point 12 can determine how long the image has been stored at the permanent storage area 16.

At step (156), the stored time for an image data file is compared to the refresh period. The refresh period is defined to be an amount of time that must transpire before an image will be considered for deletion or replacement (e.g. five years for a fracture-related x-ray). The refresh period may be set by the local PACS network 20, the storage access point 12, or by the collection of PACS networks 112. The refresh period may be different for different sized images, images from different imaging modalities, different temporary storage areas 14 or permanent storage areas 16, or other such parameters of the image or system. If the stored time is longer than the refresh period, then at step (157) it is determined that the image data should be altered and the process continues to step (52) of FIG. 1.

Since the storage of image data has associated maintenance costs and potential liability costs, it is desirable to delete copies of data within local PACS network 20. Specifically, subject to local regulations concerning medical record retention, copies of image data stored in the both the temporary storage area 14 and the permanent storage area 16 within the local PACS network 20 will be deleted when certain conditions are met. For example, some regulations require that certain types of medical data must be maintained for 17 years, and that other types of data are never to be deleted. If the stored time for an image data file is shorter than the refresh period, the process goes to step (158) where it is determined whether a change of status for the image or the patient has rendered the image data file obsolete. Data obsolescence is impacted by patient status (e.g. whether or not patient is still living), exam type (e.g. pediatric, oncology), exam age and other factors.

If so, then at step (157) it is determined that the image data should be altered and the process continues to step (52) of FIG. 1. If not, then step (150) is repeated.

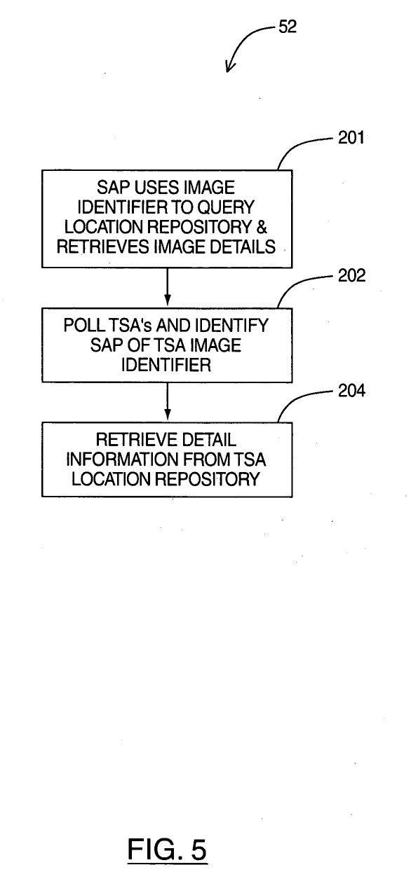

FIG. 5 is a flowchart illustrating in more detail the operational steps of the image archiving system 10 of FIG. 2 and in particular more detail associated with the process step (52) of FIG. 2. If the image data is determined to be due for alteration at step (51), then at step (52) beginning at step (200), storage access point 12 uses the unique image identifier to query the location repository 102 and clinical database 22 in order to retrieve all details associated with the target image. The image details stored in the location repository 102 and clinical database 22 may include the imaging modality 18 that created the image, the size of the image, when the image was created, what temporary storage area 14 the image is from, what part of the body the image is of, and what medical information can be obtained by looking at the medical image. Information that is specific to a particular location of an image (size, creation date etc.) will preferably be maintained at the location repository 102 while information that is the same for all copies of an image (imaging modality, body part etc) will preferably be maintained at the clinical database 22.

At step (202), storage access point 12 queries various temporary storage areas 14 to obtain information about all copies of the original image data files. One example implementation of this would be to individually and indiscriminately query each temporary storage area 14 in the collection of PACS networks 20 associated with image archiving system 10 to determine which temporary storage areas 14 have a copy of the original image data file. Each temporary storage area 14 that has a copy of the original image data file would then be asked to provide details about their copy of the image data file.

Another example implementation would be to discriminately query each temporary storage area 14 that has a copy of the image to obtain all detail information about each copy. Determining what temporary storage areas 14 have copies may be accomplished in several ways. For example, each time the permanent storage area 16 provides a copy of the image to a temporary storage area 14, the temporary storage area 14 would be entered in a list of temporary storage areas 14 having a copy of the image. The temporary storage areas 14 would be prevented from disseminating the image themselves, making all requests for copies return to the permanent storage area 16.

To get the image details from a temporary storage area 14, the storage access point 12 of the PACS network 20 that has the image in the permanent storage area 16 would provide the unique image identifier to the storage access point 12 of the local PACS network 20 of that particular temporary storage area 14. At step (204), the storage access point 12 at the location of the temporary storage area 14 queries the associated location repository 102 and retrieves details about the copy of the original image data. These details would then be provided back to the storage access point 12 at the location of the permanent storage area 16. The process continues to step (54) of FIG. 2, having obtained all the details about each of the copies of the original image data that are in use in the collection of PACS networks within image archiving system 10.

As discussed in respect of steps (53), (54), and (55), the determination of whether an image data file should be deleted in the permanent storage area 16 and/or replaced in the temporary storage area 14 is based on a number of image quality and clinical relevancy criteria. Criteria may be based on policy established by national legislation as well as the healthcare provider itself. Either party may use criteria involving all available attributes of the patient and current/prior studies, including, but not limited to: age of image, patient sex, patient age, patient medical history, patient height and/or weight, patient physician, patient location, study type, study description, body part examined, study origin (acquisition modality), study status, report status, report results (normal, abnormal). Criterion may be evaluated using an automated decision support system. Such a support system would preferably be configured to comply with national/international legislation and customer requirements.

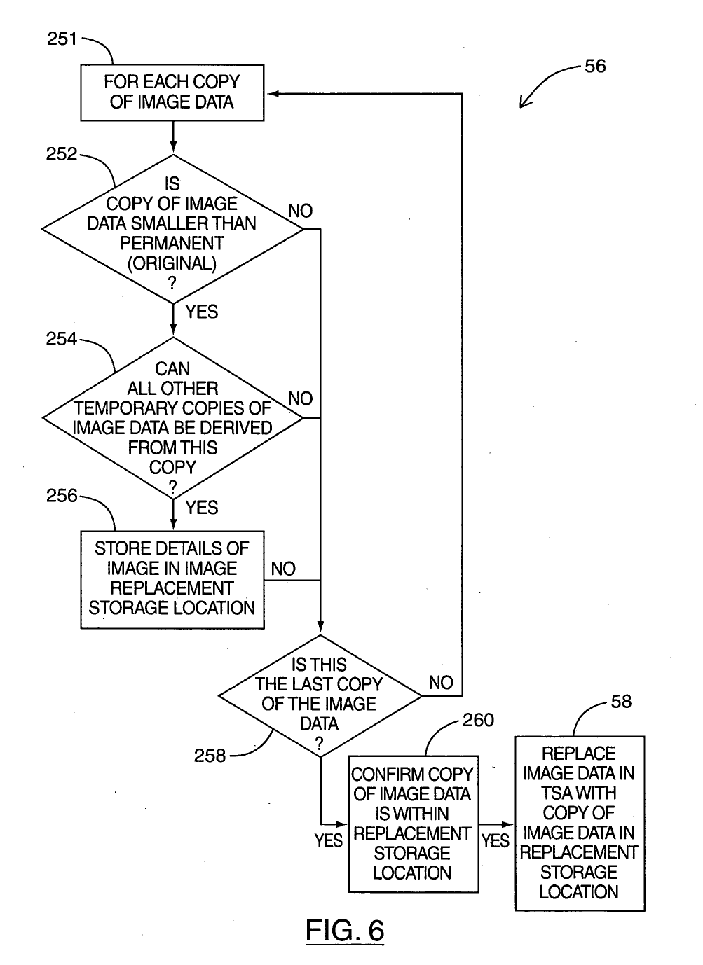

FIG. 6 is a flowchart illustrating in more detail the operational steps of the image archiving system 10 of FIG. 2 and in particular operational details associated with step (56) in FIG. 2. At this point, the replacement image data must be determined.

Step (251) begins by starting with a first copy of the image data file and will finish with the last copy of the image data file, continuing to step (256) for each individual image data file copy. At step (252), the size of the image data file copy associated with the image identified in the temporary storage area 14 is compared to the size of the related original image data file as stored in permanent storage area 16 (if available). This comparison is made using the image details that were obtained at step (204) in FIG. 5. If the size of the original image data file stored in the permanent storage area 16 is less than the size of the copy of the image data file within the temporary storage area 14, the process continues to step (258) to consider whether there is another image data file copy to consider. If the size of the copy of the image data stored in the temporary storage area 16 is less than the size of the original image data stored in the permanent storage area 14, then the process continues to step (254).

At step (254), the storage access point 12 considers whether a particular image data file copy could be used to derive all of the image data file copies that are being used at the various temporary storage areas 14. Derivation of an image data file in this context could include: applying a lossy compression algorithm (e.g. lossy JPEG) to each individual images, applying multi-image based compression (e.g. MPEG) on series of images included in a large study, selectively keeping a subset of the original images that make up a complete study (i.e. only every nth image may be kept in a large study with many images), and cropping to the original image data based on user or system identified region of interest. If so, then that particular copy of the image data is a good choice for replacement of the original image data. This process includes considering whether any copies of image data represent smaller areas of the subject's body (i.e. the image has been cropped), compressed versions of the image, lossy filtered versions of the original or a version stored in another format.

The storage access point 12 at the location of the permanent copy of the image data is preferably used to perform these comparisons. In one example implementation, these considerations are programmed in software that controls the storage access point 12, and is further designed so that a user may add or remove considerations should they choose. If the copy being considered cannot be used to obtain all the other temporary copies, the process continues to step (258) to consider whether there is another image to consider.

If the copy being considered can be used to obtain the other temporary copies, at step (256), the system stores the unique image identifier and the location of the image in the image replacement storage location. The image replacement storage location is a storage location in memory. The storage location may be for example on either the storage device 104 or the location repository 102 on the temporary storage area 14 or the permanent storage area 16.

For each image the system may proceed to step (258) to determine whether there are more images left to check, from any of steps (252), (254) or (256). If there are, the system returns to step (250). Otherwise the system proceeds to step (260). At step (260) the process checks the image replacement storage location to see if details associated with the copy of the image data are stored there and the process continues to step (58).

At step (58) all other image data file copies within temporary storage areas 16 are replaced by the image data file represented by the unique image identifier stored in the image replacement storage location. The storage access point 12 of the temporary storage area 16 accesses the unique image identifier in the image replacement storage location. This storage access point 12 then communicates with the storage access point 12 associated with other temporary storage areas 14 and instructs them to replace their current versions of the image data file with the replacement image data file. The details of the new image data file copy are then updated. This may include resetting the number of times the image has been accessed to zero, updating the size information and format.

It should be understood that the technique utilized in determining the replacement image data is only one possible approach and that there are many ways to generate or identify replacement image data, including: applying a lossy compression algorithm (e.g. lossy JPEG) to each individual images, applying multi-image based compression (e.g. MPEG) on series of images included in a large study, selectively keeping a subset of the original images that make up a complete study (i.e. only every nth image may be kept in a large study with many images), and cropping to the original image data based on user or system identified region of interest.

While image display system 10 has been described in the context of medical image management in order to provide an application-specific illustration, it should be understood that image display system 10 could also be applied to any other type of image or document display system.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An image archiving system for archiving an original image data file associated with an image, said image archiving system comprising:
(a) a permanent storage area for storing the original image data file associated with the image;
(b) a temporary storage area for storing first and second copies of the original image data file associated with the image;
(c) a processor coupled to said permanent and first temporary storage areas, said processor being adapted to:
(i) determine whether a triggering event has occurred;
(ii) if (i) is true, determine whether to replace one of the first and second copies of the original image data file within the temporary storage area;
(iii) if (ii) is true, determine whether the size of one of the said first and second copies of the original image data file is less than the size of the other of first and second copies of the original image data file and whether the said other of first and second copies of the original image data file could be derived from said one of the first and second copies of the original image data file;
(iv) if (iii) is true then replace the said other of first and second copies of the original image data file with said one of the said first and second copies of the original image data file.

2. The image archiving system of claim 1, wherein the processor determines whether a triggering event has occurred by determining whether a predetermined period of time has elapsed since the creation of the original image data file.

3. The image archiving system of claim 1, wherein the processor determines whether a triggering event has occurred by determining whether there has been a change in status of the original image data file.

4. The image archiving system of claim 1, wherein the processor determines whether said other of first and second copies of the original image data file can be derived from said one of the said first and second copies of the original image data file using filtering techniques.

5. The image archiving system of claim 1, wherein the processor determines whether said other of first and second copies of the original image data file can be derived from said one of the said first and second copies of the original image data file using compression techniques.

6. The image archiving system of claim 1, wherein the processor determines whether to replace the said other of first and second copies of the original image data file with said one of the said first and second copies of the original image data on the basis of the clinical relevance of each of said image data files.

7. The image archiving system of claim 1, wherein the processor is further adapted to:
(v) if (i) is true, determine whether to delete the original image data file from the permanent storage area and if so, delete the original image data file from the permanent storage area.

8. The image archiving system of claim 7, wherein the processor determines whether to delete the original image data file from the permanent storage area on the basis of the age of the original image data file.

9. The image archiving system of claim 7, wherein the processor determines whether to delete the original image data file from the permanent storage area on the basis of the age of the image modality that created the original image data file.

10. The image archiving system of claim 7, wherein the processor determines whether to delete the original image data file from the permanent storage area on the basis of the degradation level of the image quality associated with the original image data file.

11. The image archiving system of claim 7, wherein the processor determines whether to delete the original image data file from the permanent storage area on the basis of the clinical relevance of the original image data file.

12. A method for archiving an original image data file associated with an image, said method comprising:
(a) storing the original image data file associated with the image in a primary storage area;
(b) storing first and second copies of the original image data file in a temporary storage area;
(c) determining whether a triggering event has occurred;
(d) if (c) is true, determining whether to replace one of the first and second copies of the original image data file within the temporary storage area;
(e) If (d) is true, determining whether the size of one of the said first and second copies of the original image data file is less than the size of the other of first and second copies of the original image data file and whether the said other of first and second copies of the original image data file could be derived from said one of the first and second copies of the original image data file; and
(f) if (e) is true then replacing the said other of first and second copies of the original image data file with said one of the said first and second copies of the original image data file.

13. The method of claim 12, wherein the determination of whether a triggering event has occurred is based on whether a predetermined period of time has elapsed.

14. The method of claim 12, wherein the determination of whether a triggering event has occurred is based on whether there has been a change in status of the original image data file.

15. The method of claim 15, wherein the determination as to whether said other of first and second copies of the original image data file can be derived from said one of the said first and second copies of the original image data file is made based on filtering techniques.

16. The method of claim 15, wherein the determination as to whether said other of first and second copies of the original image data file can be derived from said one of the said first and second copies of the original image data file is made based on compression techniques.

17. The method of claim 15, wherein the determination as to whether the said other of first and second copies of the original image data file should be replaced by one of the said first and second copies of the original image data is made based on the clinical relevance of each of said image data files.

18. The method of claim 12, further comprising:
(g) if (c) is true, determining whether to delete the original image data file from the permanent storage area, and if so, deleting the original image data file from the permanent storage area.

19. The method of claim 18, wherein the determination of whether to delete the original image data file is based on the age of the original image data file.

20. The method of claim 18, wherein the determination of whether to delete the original image data file is based on the age of the image modality that created the original image data file.

21. The method of claim 18, wherein the determination of whether to delete the image data file is based on the degradation level of the image quality associated with the original image data file.

22. The method of claim 18, wherein the determination of whether to delete the image data file is based on the clinical relevance of the original image data file.

23. An image archiving system for archiving an original image data file associated with an image, said image archiving system comprising:
(a) a permanent storage area for storing the original image data file associated with the image;
(b) a processor coupled to said permanent area, said processor being adapted to:
(i) determine whether a triggering event has occurred;
(ii) if (i) is true, determine whether to delete the original image data file from the permanent storage area, and if so, deleting the original image data file from the permanent storage area.

24. The image archiving system of claim 23, wherein the processor determines whether a triggering event has occurred by determining whether a predetermined period of time has elapsed since the creation of the original image data file.

25. The image archiving system of claim 23, wherein the processor determines whether a triggering event has occurred by determining whether there has been a change in status of the original image data file.

26. The image archiving system of claim 23, wherein the processor determines whether to delete the original image data file from the permanent storage area on the basis of the age of the original image data file.

27. The image archiving system of claim 23, wherein the processor determines whether to delete the original image data file from the permanent storage area on the basis of the age of the image modality that created the original image data file.

28. The image archiving system of claim 23, wherein the processor determines whether to delete the original image data file from the permanent storage area on the basis of the degradation level of the image quality associated with the original image data file.

29. The image archiving system of claim 23, wherein the processor determines whether to delete the original image data file from the permanent storage area on the basis of the clinical relevance of the original image data file.

30. The image archiving system of claim 23, further comprising a temporary storage area for storing first and second copies of the original image data file associated with the image, said temporary storage area being coupled to the processor, and wherein said processor is further adapted to:
(iii) if (i) is true, determine whether to replace one of the first and second copies of the image data file within the temporary storage area;
(iv) if (iii) is true, determine whether the size of one of the said first and second copies of the original image data file is less than the size of the other of first and second copies of the original image data file and whether the said other of first and second copies of the original image data file could be derived from said one of the first and second copies of the original image data file; and
(v) if (iv) is true then replace the said other of first and second copies of the original image data file with said one of the said first and second copies of the original image data file.

31. The image archiving system of claim 30, wherein the processor determines whether said other of first and second copies of the original image data file can be derived from said one of the said first and second copies of the original image data file using filtering techniques.

32. The image archiving system of claim 30, wherein the processor determines whether said other of first and second copies of the original image data file can be derived from said one of the said first and second copies of the original image data file using compression techniques.

33. The image archiving system of claim 30, wherein the processor determines whether to replace the said other of first and second copies of the original image data file with said one of the said first and second copies of the original image data on the basis of the clinical relevance of each of said image data files.

34. A method for archiving an original image data file associated with an image, said method comprising:
(a) storing the original image data file associated with the image in a primary storage area;
(b) determining whether a triggering event has occurred;
(c) if (b) is true, determining whether to delete the original image data file from the permanent storage area, and if so, deleting the original image data file from the permanent storage area.

35. The method of claim 34, wherein the determination of whether a triggering event has occurred is based on whether a predetermined period of time has elapsed.

36. The method of claim 34, wherein the determination of whether a triggering event has occurred is based on whether there has been a change in status of the original image data file.

37. The method of claim 34, wherein the determination of whether to delete the original image data file is based on the age of the original image data file.

38. The method of claim 34, wherein the determination of whether to delete the original image data file is based on the age of the image modality that created the original image data file.

39. The method of claim 34, wherein the determination of whether to delete the image data file is based on the degradation level of the image quality associated with the original image data file.

40. The method of claim 34, wherein the determination of whether to delete the image data file is based on the clinical relevance of the original image data file.

41. The method of claim 34, further comprising:
(d) storing first and second copies of the original image data file in a temporary storage area;
(e) if (b) is true, determining whether to replace one of the first and second copies of the image data file within the temporary storage area;
(f) If (e) is true, determining whether the size of one of the said first and second copies of the original image data file is less than the size of the other of first and second copies of the original image data file and whether the said other of first and second copies of the original image data file could be derived from said one of the first and second copies of the original image data file; and
(g) if (f) is true then replacing the said other of first and second copies of the original image data file with said one of the said first and second copies of the original image data file.

42. The method of claim 41, wherein the determination as to whether said other of first and second copies of the original image data file can be derived from said one of the said first and second copies of the original image data file is made based on filtering techniques.

43. The method of claim 41, wherein the determination as to whether said other of first and second copies of the original image data file can be derived from said one of the said first and second copies of the original image data file is made based on compression techniques.

44. The method of claim 41, wherein the determination as to whether the said other of first and second copies of the original image data file should be replaced by one of the said first and second copies of the original image data is made based on the clinical relevance of each of said image data files.
